(19) United States
(12) Patent Application Publication
(10) Pub. No.: US 2011/0138960 A1
(43) Pub. Date: Jun. 16, 2011

(54) DRIVE DEVICE FOR A FURNITURE FLAP

(76) Inventors: Christian OMANN, Hard (AT); Wofgang Bohle, Gotzis (AT)

(21) Appl. No.: 13/033,955

(22) Filed: Feb. 24, 2011

Related U.S. Application Data
(63) Continuation of application No. PCT/AT2009/000290, filed on Jul. 28, 2009.

(30) Foreign Application Priority Data
Aug. 29, 2008 (AT) A 1347/2008

(51) Int. Cl. E05F 1/10; A47B 95/00

(52) U.S. Cl. 74/490.07

(57) ABSTRACT

Drive device for a flap of a piece of furniture, having at least one actuating arm which is, or can be, activated by a spring device and is intended for moving the flap, and having a pushing-out device, via which the flap can be moved from the closed position, in the direction of the open position, over a first opening-angle range (M1), wherein the spring device exerts substantially no force on the flap in the first opening-angle range (M1), and the spring device moves the flap in the opening direction only in a second opening-angle range (M2), wherein the second opening-angle range (M2) adjoins the first opening-angle range (M1) or, at most, slightly overlaps the same.

The present invention relates to a drive device for a flap of an article of furniture having at least one actuating arm which is or can be acted upon by a spring device for moving the flap and an ejector device by way of which the flap is movable over a first opening angle range from the closed position in the direction of the open position.

The invention further concerns an article of furniture having a drive device of the kind to be described.

Such a drive device is known for example from German Utility Model specification DE 20 2006 000 535 U1 to the present applicant, wherein there is provided an ejector device having a Touch-latch functionality for ejecting the flap from a closed end position. There is also an additional spring device which provides compensation for the weight of the flap. The spring device however also applies to the flap a relatively high force for holding the flap closed so that towards the end of the closing movement, after moving beyond a dead center point position, the flap is pushed towards the fully closed position and is held in that end position by a given closing force. A disadvantage with that state of the art is the fact that the ejector device—when the flap in the completely closed position—has to overcome the force of the spring device, and that also requires an ejector device of relatively great dimensions.

It is therefore an object of the present invention to provide a drive device of the general kind set forth in the opening part of this specification, avoiding the above-mentioned disadvantage.

According to the invention in an advantageous configuration that is achieved in that the spring device exerts substantially no force on the flap in the first opening angle range and the spring device moves the flap in the opening direction only in a second opening angle range, wherein the second opening angle range adjoins the first opening angle range or at most somewhat overlaps therewith.

In other words the ejector device and the spring device are so matched to each other that in the closed position the spring device exerts substantially no force on the flap so that the ejector device, for ejection of the flap, has to overcome substantially only the moment of inertia of the flap (having regard to the angular speed to be achieved by the flap). The flap can thus be particularly easily moved out of the closed end position.

The force of the ejector device can be relatively low in that way and it can thus be of a space-saving and inexpensive implementation. It is only towards the end of the ejection stroke movement of the ejector device—preferably subsequently to that ejection stroke movement—that the spring device begins to act so that an active pivotal moment is exerted in the opening direction on the actuating arm (and thus on the flap pivotably connected thereto) so that the flap is moved automatically upwardly by the force of the spring device.

In an embodiment it can be provided that the drive device has precisely one spring device. In principle it is admittedly conceivable that the drive device could include two or more spring devices which however are all operative in the second opening angle range (for example in the form of a relay race). In an aspect of the invention however it is desirable if the spring device or devices exerts or exert no pulling closure force on the flap in the first opening angle range or does not provide any spring force which holds the flap in the completely closed position.

In an embodiment of the invention it can be provided that adjoining the second opening angle range is a third opening angle range in which the spring device holds the flap in substantially balanced relationship. In that way the flap is held substantially in any open position in a range immediately prior to the completely open position, whereby the flap is not necessarily pushed towards the fully open position. It will be noted however that it is also possible for the flap also to be moved into the fully open position by the spring device and a damping device can be provided for damping the last opening movement of the flap.

In a possible embodiment of the invention it can be provided that the first opening angle range—starting from the completely closed position of the flap—extends between 0° and 10°, preferably between 0° and 5°. It may also be desirable if the second opening angle range is operative up to about 30°, preferably about 10°, in the open position of the flap.

An advantageous configuration is afforded if a control cam mounted about an axis of rotation and with an actuating contour formed or arranged thereon is operative between the spring device and the actuating arm, wherein a pressure roller runs against the actuating contour during the pivotal movement of the actuating arm. In that connection it may be advantageous if the curve portion of the actuating contour—which is in engagement with the pressure roller during the first opening angle range of the flap—has at least approximately the same radial spacing relative to the axis of rotation of the control cam. The approximately equal radial spacing of that cam portion makes it possible to avoid the spring device exerting a substantial force on the flap in the very last closing range. It would at most even be possible to tolerate a slight closing force on the part of the spring device as long as the opposite force of the ejector device is correspondingly greater.

To achieve a particularly compact structure it may be desirable if the spring device and the ejector device are arranged in a common structural unit. It will be appreciated that it is also possible for the spring device and the drive device to be arranged in mutually separate structural units. In that way existing actuating drives can possibly be subsequently fitted with an ejector device.

It can be provided that the ejector device acts directly or indirectly on the flap. Alternatively or supplementally however it is also possible for the ejector device to act on the actuating arm. In a desirable configuration it can be provided that the ejector device has at least one, preferably lockable, force storage means, by which an ejector element can be acted upon for ejection of the flap and/or for ejection of the actuating arm.

There are a number of possible options for implementing the ejector device. In this connection all Touch-latch functionalities known from the state of the art can be considered, as is also described inter alia in DE 20 2006 000 535 U1 to the present applicant. The force storage means can therefore have at least one mechanical spring element and/or can be at least partially formed by an electric motor. Force storage means in the form of gas pressure springs and/or a solenoid can also be envisaged. The force storage means can be loaded up upon opening or upon closing, in which case the Touch-latch fitment can be triggered by pulling on the flap and/or by manually exerting pressure on the flap (starting from the closed position). In the case of triggering by exerting pressure on the flap it may be desirable if the flap has a first end position which corresponds to the closed position of the flap and that the flap, starting from that first end position, is movable by exerting pressure in the closing direction thereof into a second end position closer to the furniture carcass.

So that the flap is sufficiently stably held relative to the furniture carcass in the completely closed position, it may be desirable if the flap is held in the closed position by a restraining device. Thus there can be provided a per se known structure, wherein the restraining device includes at least two portions, wherein a first portion is or can be arranged on the furniture carcass and a second portion is or can be arranged on the flap, wherein the two portions exert a magnetic attraction force on each other in the closed position of the flap.

Alternatively a pull-in device can also be used as the restraining device, as have for example already long been known in relation to drawer extension guide arrangements. As an example in that respect attention is to be directed to EP 0 391 221 B1 to the present applicant. Those pull-in devices usually have at least one coupling portion, wherein a coupling portion associated with the furniture carcass can be coupled to an entrainment member associated with the flap towards the end of the flap closing movement, whereupon the coupled entrainment member (and therewith the flap) can be pulled into the completely closed position by a force storage device. It will be appreciated that that closing movement can also be damped by a damper to prevent the flap from hitting hard against the furniture carcass.

The restraining device can in principle also be in the form of a simple locking device which can be released again by the ejector device. It will be appreciated that in all variants of the restraining device the force of the ejector device, that is in opposition to the restraining device, must be sufficiently higher to permit the flap to be reliably ejected from the closed end position.

Further details and advantages of the present invention will be described with reference to the specific description hereinafter. In the drawing:

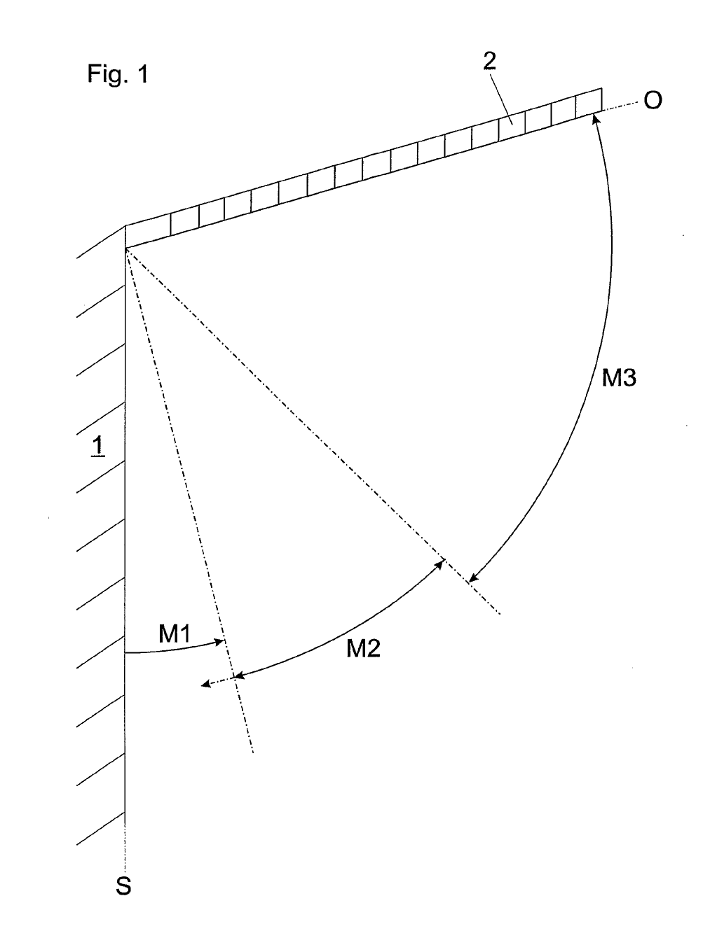

FIG. 1 shows a diagrammatic view of the opening angle ranges of the flap,

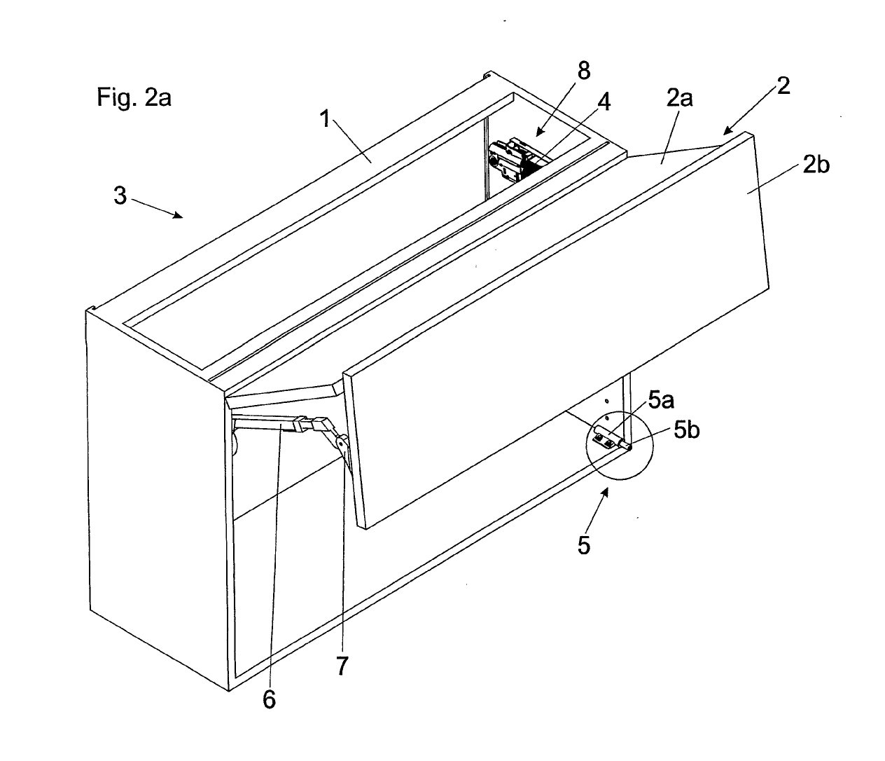

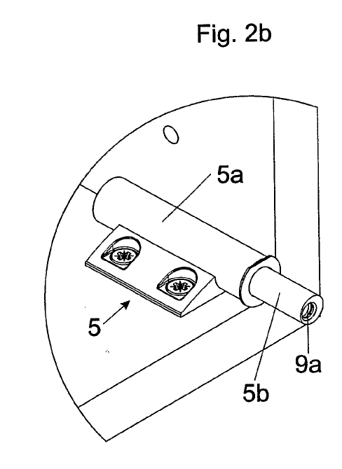

FIGS. 2a, 2b show a perspective view from the front and an enlarged detail view thereof of the article of furniture,

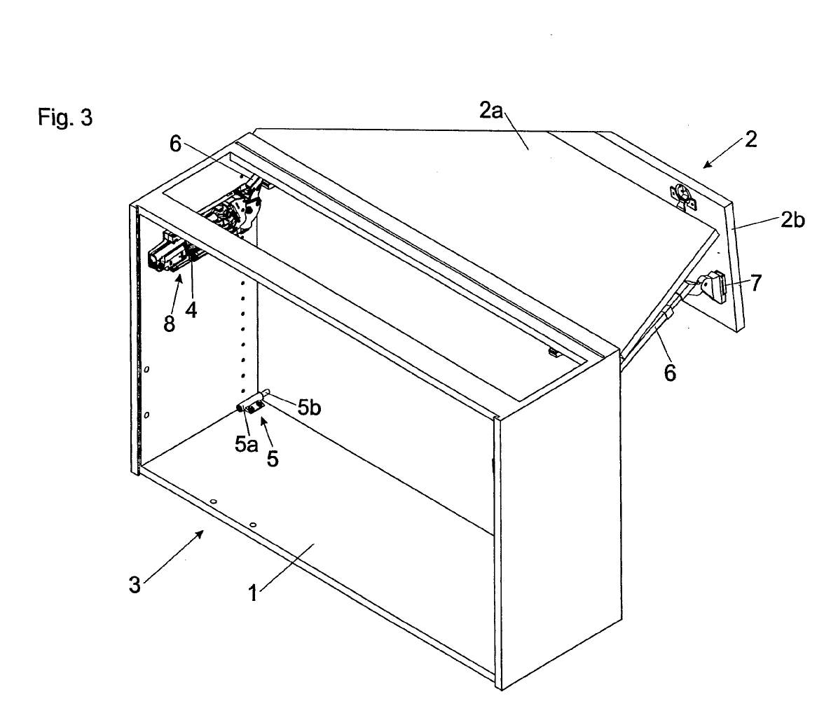

FIG. 3 shows a perspective view from the rear of the article of furniture,

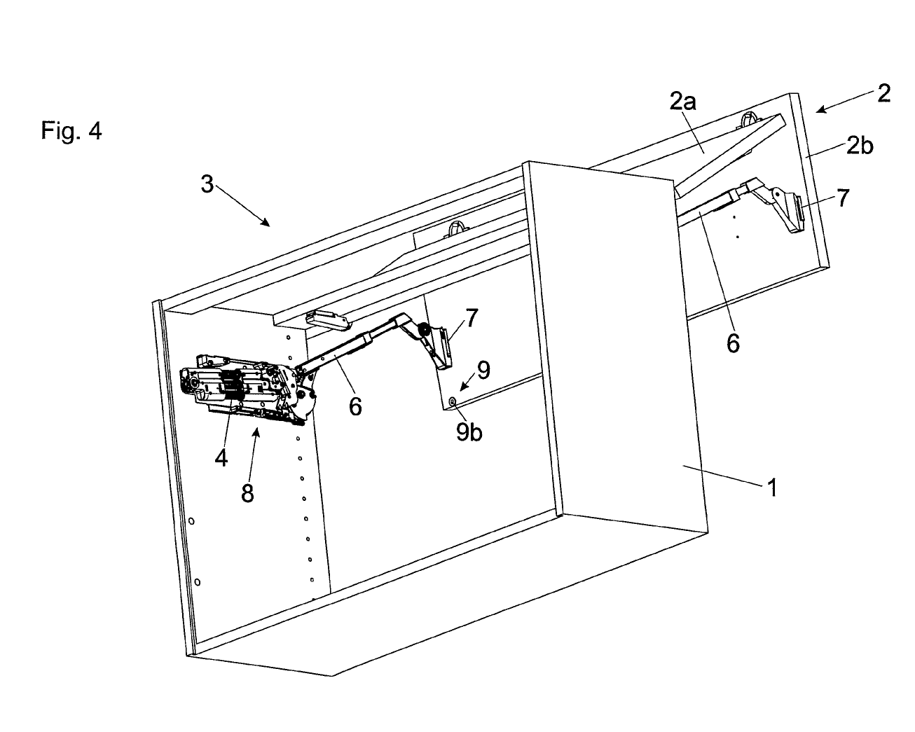

FIG. 4 shows a further perspective view from the rear of the article of furniture, and

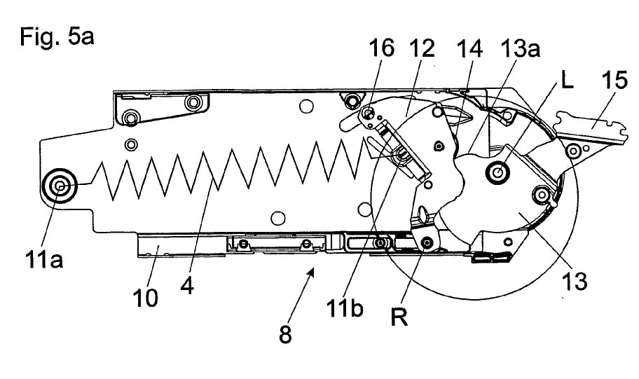

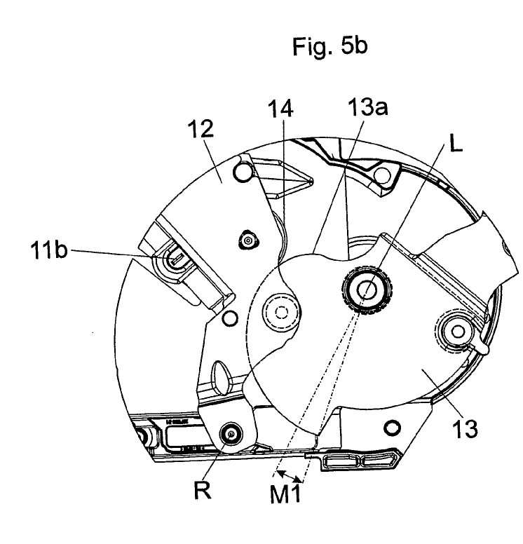

FIGS. 5a, 5b show a possible embodiment of an actuating drive for moving the flap.

FIG. 1 shows a diagrammatic view of the various opening angle ranges M1, M2 and M3 of a flap 2 which is movable upwardly relative to a furniture carcass 1. In this diagrammatic view the flap 2 is in the completely open position. The flap 2 is mounted movably between a vertical position closing a cupboard compartment in the furniture carcass 1 (characterized by the vertical axis S) and an upwardly moved open position (axis O). An ejector device (not shown) is provided for ejecting the flap 2 from the closed position while a spring device (also not shown) is provided to compensate for or to at least partially assist with the opening movement. Starting from the completely closed position of the flap 2 (vertical axis S) it is moved by the ejector device over the first opening angle range M1 in the direction of the open position, wherein substantially no force is exerted on the flap 2 by the spring device in that first opening angle range M1. In that way the flap 2 can be particularly easily moved out of the closed position. Towards the end of the first opening angle range M1 there is a second opening angle range M2 which either adjoins the first opening angle range M1 or at most somewhat overlaps therewith. That overlap is symbolically identified by the broken extension line of the second opening angle range M2. In the second opening angle range M2 an active pivotal movement is exerted on the flap 2 by the provided spring device so that following the ejection stroke movement of the ejector device the flap 2 is moved in the direction of the open position by the spring device (also without manual assistance for the flap 2). Provided subsequently to the second opening angle range M2 there is a third opening angle range M3 in which the spring device holds the flap 2 in a substantially tared condition. In that case therefore the flap 2 is held within the third opening angle range M3 substantially in any pivotal position against the force of gravity so that the flap 2 is not automatically pushed into the completely open position, for reasons of improved accessibility.

FIG. 2a shows a possible embodiment of an article of furniture 3, wherein an upwardly movable flap 2 is mounted displaceably relative to a furniture carcass 1. The flap 2 in the illustrated Figure includes two flap portions 2a and 2b, wherein the upper flap portion 2a is pivotable relative to the furniture carcass 1 and the lower flap portion 2b is mounted rotationally hingedly relative to the upper flap portion 2a. In the illustrated view the flap 2 is an open position. When the flap 2, starting from the illustrated position, is moved into the closed position, the two flap portions 2a and 2b move away from each other again until in the closed position they form a common plane and in that case close the cupboard compartment of the furniture carcass 1 in a vertical position. To move the flap 2 there is firstly provided an actuating drive 8 having a spring device 4 acting on an actuating arm 6. The actuating drive 8 is preferably mounted to both oppositely disposed side walls of the furniture carcass 1. The actuating arm 6 of the right-hand actuating drive 8 is concealed by the flap 2 in the illustrated Figure. In addition, to move the flap 2, there is an ejector device 5 by which the flap 2 is movable starting from the completely closed position over the first opening angle range M1 shown in FIG. 1. For reasons of clarity the ejector device 5 is illustrated as a structural unit separate from the actuating drive 8, but it will be appreciated that the ejector device 5 can also be integral part of the actuating drive 8. The spring device 4 of the actuating drive 8 exerts substantially no force on the actuating arm 6 in the immediate proximity with the completely closed position so that the flap 2 is particularly easily movable into an open position by the ejector device 5. The actuating arm 6 is on the one hand mounted about a horizontal axis relative to the furniture carcass 1 while on the other hand it is pivotably connected about an also horizontal axis to a fitment 7 associated with the lower flap portion 2b.

FIG. 2b shows an enlarged view of the region circled in FIG. 2a. It is possible to see the ejector device 5 which has a housing 5a and an ejector element 5b which is mounted movably relative to the housing 5a. As in the discussed embodiment the ejector element 5b can be linearly displaceable relative to the housing 5a. The ejector device 5 has for example a Touch-latch functionality, wherein a lockable force storage means is arranged within the housing 5a. As shown the ejector element 5b can act on the flap 2 or, in a variant, also on the actuating arm 6. The ejector device 5 can be triggered either by pressure applied to the flap 2 or by pulling on the flap 2. More details of the functionality of such touch-latch devices will not be described in the context of the present invention as they have long been known in the state of the art.

It is also possible to see in FIG. 2b a portion 9a forming a portion of a restraining device 9 for holding the flap 2 closed. The restraining device 9 serves for fixing the flap in the completely closed position and is described in greater detail hereinafter.

FIG. 3 shows a perspective view from the rear of the article of furniture 3, the rear wall of the furniture carcass 1 being omitted for the sake of enhanced clarity of the drawing. It is possible to see the actuating drive 8 with the spring device 4, by which the actuating arm 6 can be acted upon to move the flap 2. The ejector device 5, arranged on or in the furniture carcass 1, with the housing 5a and the ejector element 5b movable relative thereto in the form of a push rod, acts on the lower flap portion 2b in the closed position.

FIG. 4 also shows a perspective view from the rear of the article of furniture 3. It is possible to see here a portion 9b of a restraining device 9 by which the flap 2 can be sufficiently stably held in the completely closed position. In the illustrated Figure the restraining device 9 includes a portion 9b which in the closed position of the flap 2 is magnetically connected to a portion 9a arranged in the ejector element 5b (FIG. 2b). In that way the flap 2 is sufficiently stably held to the furniture carcass, but the magnetic force can be overcome by triggering the ejector device 5 so that the flap 2 is movable into an open position.

FIG. 5a shows a possible embodiment of an actuating drive 8 to be fixed to at least one side wall of the furniture carcass 1. The actuating drive 8 includes a housing 10 with a first spring mounting 11a at which the diagrammatically illustrated spring device 4 is supported. In addition there is an intermediate lever 12 which is pivotable about the axis of rotation R, the spring device 4 acting on the second spring mounting 11b on the intermediate lever 12. The spring mounting 11b is displaceable by an adjusting device 16 in a variable state relative to the axis of rotation R of the intermediate lever 12 so that the force of the spring device 4 can be selectively adjusted to the weight of the flap 2 to be moved. In addition there is a control cam 13 which is mounted rotatably about the axis of rotation L and has an actuating contour 13a, wherein a pressure roller 14 associated with the intermediate lever 12 is pressed against the actuating contour 13a of the control cam 13 by the force of the spring device 4. During the closing movement of the actuating arm 6 (not shown here) the pressure roller 14 runs along the actuating contour 13a of the control cam 13. The rotatable control cam 13 has a coupling portion 15 onto which the actuating arm 6 can be snapped.

FIG. 5b shows an enlarged view of the region circled in FIG. 5a. It is possible to see the intermediate lever 12 which is pivotable about the axis of rotation R and on which the displaceably mounted spring mounting 11b is arranged. The pressure roller 14 is pressed against the actuating contour 13a of the control cam 13 mounted about the axis of rotation L, the pressure roller 14 running against the peripheral edge (actuating contour 13a) of the control cam 13. The Figure diagrammatically shows the first rotary angle range M1, wherein the radial spacing—with respect to the axis of rotation L of the control cam 13—of the actuating contour 13a is at least approximately the same in that rotary angle range M1. In that way substantially no force is exerted on the actuating arm 6 (and thus on the flap 2) by the spring device so that the flap 2, starting from the completely closed position, is movable into an open position by an ejector device 5 which applies a relatively low force.

The present invention is not limited to the illustrated embodiment but includes or extends to all variants and technical equivalents which can fall within the scope of the claims appended hereto. The positional references adopted in the description such as for example up, down, right and so forth are related to the directly described and illustrated Figure and are to be appropriately transferred to the new position upon a change in position.

1. A device comprising a drive device for a flap of an article of furniture with at least one actuating arm which is or can be acted upon by a spring device for moving the flap, and an ejector device by way of which the flap is movable over a first opening angle range from a closed position in the direction of the open position, said spring device exerts substantially no force on the flap in a first opening angle range and said spring device moves the flap in the opening direction only in a second opening angle range, wherein the second opening angle range adjoins the first opening angle range or at most somewhat overlaps therewith.

2. The drive device according to claim 1, wherein adjoining said second opening angle range is a third opening angle range in which said spring device holds the flap in substantially tared relationship.

3. The drive device according to claim 1, wherein said first opening angle range—starting from a completely closed position of the flap—extends between 0° and 10°, preferably between 0° and 5°.

4. The drive device according to claim 1, wherein said second opening angle range is operative up to about 30°, preferably about 10°, in the open position of the flap (2).

5. The drive device according to claim 1, wherein a control cam mounted about an axis of rotation and with an actuating contour formed or arranged on said control cam is operative between said spring device and said actuating arm, wherein a pressure roller runs against said actuating contour during a pivotal movement of said actuating arm.

6. The drive device according to claim 5, wherein a curve portion of said actuating contour which is in engagement with said pressure roller during said first opening angle range of the flap is at at least approximately the same radial spacing relative to said axis of rotation of said control cam.

7. The drive device according to claim 1, wherein said spring device and said ejector device are arranged in a common structural unit.

8. The drive device according to claim 1, wherein said spring device and said ejector device are arranged in structural units which are separate from each other.

9. The drive device according to one claim 1, wherein said ejector device acts on the flap.

10. The drive device according to claim 1, wherein said ejector device acts on said actuating arm.

11. The drive device according to claim 1, wherein said ejector device has at least one, preferably lockable, force storage means, by which an ejector element can be acted upon for ejection of the flap and/or for ejection of said actuating arm.

12. The drive device according to claim 1, wherein the flap is held in a closed position by a restraining device.

13. The drive device according to claim 12, wherein said restraining device includes at least two portions, wherein a first portion is or can be arranged on the furniture carcass and a second portion is or can be arranged on the flap, wherein the two portions exert a magnetic attraction force on each other in the closed position of the flap.

14. The drive device according to claim 1, wherein said drive device has precisely one spring device.

15. An article of furniture having a drive device according to claim 1.
